(19) United States
(12) Patent Application Publication
(10) Pub. No.: US 2025/0363964 A1
(43) Pub. Date: Nov. 27, 2025

(54) MEDIA DOCKING DEVICE

(71) Applicant: Realtek Semiconductor Corporation, Hsinchu (TW)

(72) Inventors: Bo Yu LAI, Hsinchu (TW); You-Wen CHIOU, Hsinchu (TW); Kuan-Chi CHOU, Hsinchu (TW); Tsung-Han LI, Hsinchu (TW); Tien-Wei KAO, Hsinchu (TW); Chien-Wei CHEN, Hsinchu (TW)

(21) Appl. No.: 19/216,697

(22) Filed: May 22, 2025

Related U.S. Application Data
(60) Provisional application No. 63/650,920, filed on May 23, 2024.

(30) Foreign Application Priority Data
Jan. 10, 2025 (TW) 114101163

(51) Int. Cl. G09G 5/00

(52) U.S. Cl. CPC G09G 5/006; G09G 2350/00; G09G 2370/042; G09G 2370/12

(57) ABSTRACT

A media docking device includes an input interface controller, an output interface controller, and a processor. The input interface controller is connected to a media source device. The output interface controller is connected to media player devices and obtains device data of each media player device. The processer calculates a display bandwidth required by each media player device to display image based on the device data, and sums the display bandwidths of the media player devices to obtain a total display bandwidth. The processor determines an optimal support mode for connecting a video interface unit of the input interface controller to the media source device based on the total display bandwidth. A transmission bandwidth corresponding to the optimal support mode is greater than the total display bandwidth, and a difference between the transmission bandwidth and the total display bandwidth is less than a threshold.

### CROSS-REFERENCE TO RELATED APPLICATION

This application claims priority to U.S. Provisional Application Ser. No. 63/650,920, filed May 23, 2024, and Taiwan Application Serial Number 114101163, filed Jan. 10, 2025, the disclosures of which are incorporated herein by reference in their entireties.

### BACKGROUND

### Field of Invention

The present disclosure relates to a media docking device. More particularly, the present disclosure relates to a media docking device that can properly adjust transmission bandwidth to achieve effect of power saving.

### Description of Related Art

In scenario of business office, it has become common for a laptop to be connected to plural monitors via an external docking station. A user can carry the laptop to different locations, and each of these locations can be equipped with the docking station and the monitors. When the docking station is connected to the monitors, these monitors can be regarded as an extension of the display screen of the laptop. However, excessive power consumption of the docking station will cause life of the battery of the laptop to be significantly reduced. Therefore, an issue that concern technicians in this field is to reduce the power consumption of the docking station without affecting the experience of the user.

### SUMMARY

The present disclosure provides a media docking device. The media docking device includes an input interface controller, an output interface controller, and a processor. The input interface controller is connected to a media source device. The output interface controller is connected to at least one media player device and obtains device data of each of the at least one media player device. The processer is connected to the input interface controller and the output interface controller. The processer calculates display bandwidths required by the at least one media player device to display image based on the device data. The processer sums the display bandwidths to obtain a total display bandwidth. The processor determines an optimal support mode for connecting a video interface unit of the input interface controller to the media source device based on the total display bandwidth. A transmission bandwidth corresponding to the optimal support mode is greater than the total display bandwidth, and a difference between the transmission bandwidth corresponding to the optimal support mode and the total display bandwidth is less than a threshold.

The present disclosure provides a media docking method. The media docking method includes: obtaining device data of each of the at least one media player device through an output interface controller; calculating display bandwidths required by the at least one media player device to display image based on the device data; summing the display bandwidths to obtain a total display bandwidth; and determining an optimal support mode for connecting a video interface unit of an input interface controller to a media source device based on the total display bandwidth. A transmission bandwidth corresponding to the optimal support mode is greater than the total display bandwidth, and a difference between the transmission bandwidth corresponding to the optimal support mode and the total display bandwidth is less than a first threshold.

In order to make the above features and advantages of the present disclosure more apparent and understandable, the following embodiments of the present disclosure, together with the accompanying drawings, are described in detail below.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a circuit diagram of a media docking device according to embodiments of the present disclosure.

FIG. 2 is a flowchart of a media docking method according to embodiments of the present disclosure.

### DETAILED DESCRIPTION

Specific embodiments of the present disclosure are further described in detail below with reference to the accompanying drawings. However, the embodiments described are not intended to limit the present disclosure and it is not intended for the description of operations to limit the order of implementation. The terms “first” and “second” used in the specification should be understood as identifying units or data described by the same terminology, and do not refer to a particular order or sequence.

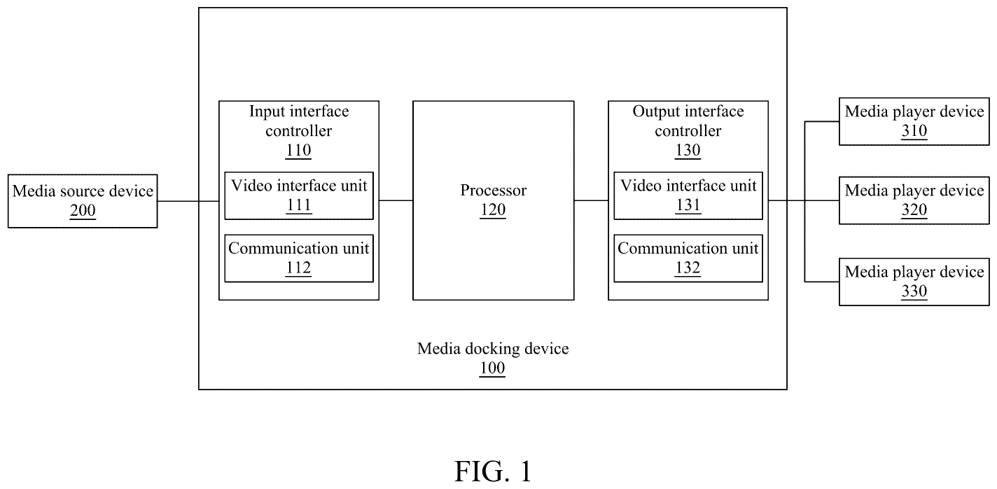

FIG. 1 is a circuit diagram of a media docking device 100 according to embodiments of the present disclosure. The media docking device 100 includes an input interface controller 110, a processor 120, and an output interface controller 130. The processor 120 is electrically connected to the input interface controller 110 and the output interface controller 130.

The input interface controller 110 is electrically connected to a media source device 200. The media source device 200 is, for example, a laptop, a desktop computer, a tablet, or a smart phone. The input interface controller 110 includes a video interface unit 111 and a communication unit 112. The video interface unit 111 is an audio and video transmission interface between the input interface controller 110 and the media source device 200. The video interface unit 111 is, for example, a circuit that complies with the specifications of DisplayPort (DP) or High Definition Multimedia Interface (HDMI). The communication unit 112 is a data transmission interface between the input interface controller 110 and the media source device 200. The communication unit 112 is, for example, a circuit that complies with the specifications of Auxiliary (AUX) channel, inter-integrated circuit (I²C), Ethernet, universal serial bus (USB), Consumer Electronics Control (CEC), display data channel (DDC), or display data channel command interface (DDCCI). The above-mentioned various transmission interfaces and the specifications are merely examples, and the present disclosure is not limited thereto.

The processor 120 includes a processing unit and a memory. The processing unit is, for example, a central processing unit (CPU), a microprocessor, a microcontroller, or an application-specific integrated circuit (ASIC). The memory is, for example, a random access memory (RAM), a read-only memory (ROM), or a flash memory.

The output interface controller 130 is electrically connected to the media player devices 310, 320, and 330. The media player devices 310, 320, and 330 are devices with display functions, such as monitors, projectors, or tablets. The media player devices 310, 320, and 330 can be regarded as an extension of the display screen of the media source device 200. The number of media player devices as shown in FIG. 1 is only an example, and the present disclosure is not limited thereto. Specifically, the number of media player devices in the embodiments of the present disclosure is at least one.

The output interface controller 130 includes a video interface unit 131 and a communication unit 132. The video interface unit 131 is an audio and video transmission interface between the output interface controller 130 and the media player devices 310, 320, and 330. The video interface unit 131 is, for example, a circuit that complies with the specifications of DP or HDMI. The communication unit 132 is a data transmission interface between the output interface controller 130 and the media player devices 310, 320, and 330. The communication unit 132 is, for example, a circuit that complies with the specifications of AUX channel, I²O, Ethernet, USB, CEC, DDC, or DDCCI. The above-mentioned various transmission interfaces and the specifications are merely examples, and the present disclosure is not limited thereto.

In conventional technology, the input interface controller of the media docking device performs link training with the media source device, thereby determining the support mode (hereinafter referred to as input support mode, which corresponds to a certain transmission bandwidth) for connecting the video interface unit of the input interface controller of the media docking device to the media source device. On the other hand, the output interface controller of the media docking device also performs link training with the media player device, thereby determining the support mode (hereinafter referred to as output support mode) for connecting the video interface unit of the output interface controller of the media docking device to the media player device. However, the aforementioned two link trainings are independent, and thus the transmission bandwidth corresponding to the input support mode may be much larger than the transmission bandwidth corresponding to the output support mode. This will cause a redundant portion of the transmission bandwidth corresponding to the input support mode, thereby resulting in unnecessary waste of transmission bandwidth corresponding to the input support mode. In addition, the larger transmission bandwidth will also make the media docking device consume more energy, thereby significantly reducing life of the battery of the media source device that supplies power to the media docking device.

In order to solve the aforementioned problem, the present disclosure provides a media docking device that can properly adjust transmission bandwidth to achieve effect of power saving.

The communication unit 132 of the output interface controller 130 of the media docking device 100 obtains device data of each of the media player devices 310, 320, and 330 from the media player devices 310, 320, and 330. The device data is one of fields of extended display identification data (EDID), and the device data is used to declare a pixel clock. In other words, the aforementioned one of the fields of EDID contains information of the pixel clock.

Next, the processor 120 calculates a display bandwidth required by each of the media player devices 310, 320, and 330 to display image based on the device data. For example, the pixel clock of a monitor with a resolution of 4K/60 Hz is 533 MHz. Therefore, the display bandwidth required to output 8-bit RGB (color depth) at the resolution of 4K/60 Hz is 533*3 (RGB)=1599 MB/s. For example, the pixel clock of a monitor with a resolution of FHD/60 Hz is 148.5 MHz. Therefore, the display bandwidth required to output 8-bit RGB (color depth) at the resolution of FHD/60 Hz is 148.5*3 (RGB)=445.5 MB/s.

Then, the processor 120 sums the display bandwidths of the media player devices 310, 320, and 330 to obtain a total display bandwidth. For example, the display bandwidth required for the monitor with the resolution of FHD/60 Hz is 445.5 MB/s, so the total display bandwidth required for three monitors with the resolution of FHD/60 Hz is 445.5*3=1336.5 MB/s.

Afterwards, the processor 120 determines the input support mode (hereinafter referred to as the “optimal support mode”) for connecting the video interface unit 111 of the input interface controller 110 to the media source device 200 based on the total display bandwidth. A transmission bandwidth corresponding to the optimal support mode is greater than the total display bandwidth. In embodiments of the present disclosure, a difference between the transmission bandwidth corresponding to the optimal support mode and the total display bandwidth is less than a first threshold. The first threshold can be set according to actual needs. The first threshold is, for example, 850 MB/s, but the present disclosure is not limited thereto. The optimal support mode includes a bit rate configuration via N lanes. The bit rate configuration is reduced bit rate (RBR), high bit rate (HBR), high bit rate 2 (HBR2), high bit rate 3 (HBR3), ultra-high bit rate 10 (UHBR10), ultra-high bit rate 13.5 (UHBR13.5), or ultra-high bit Rate 20 (UHBR20). N is 1, 2 or 4.

For example, if the media player devices 310, 320, and 330 are three monitors with the resolution of FHD/60 Hz, and thus the total display bandwidth is 1336.5 MB/s, such that the optimal support mode can be determined to be HBR3/2-lanes or HBR2/4-lanes. The transmission bandwidth corresponding to HBR3/2-lanes is 8.1 (Gbps)*2 (lanes)*1000 (Mbps/Gbps)*⅛ (Byte/bits)* 8/10 (8b/10b encoding)=1620 MB/s, which is greater than the total display bandwidth of 1336.5 MB/s, and the difference between the transmission bandwidth corresponding to HBR3/2-lanes and the total display bandwidth is less than 850 MB/s. The transmission bandwidth corresponding to HBR2/4-lanes is 5.4 (Gbps)*4 (lanes)*1000 (Mbps/Gbps)*⅛ (Byte/bits)* 8/10 (8b/10b encoding)=2160 MB/s, which is also greater than the total display bandwidth of 1336.5 MB/s, and the difference between the transmission bandwidth corresponding to HBR2/4-lanes and the total display bandwidth is also less than 850 MB/s.

For another example, if the number of the media player device is one and this media player device is a monitor with the resolution of 4K/60 Hz, and thus the total display bandwidth is 1599 MB/s, such that the optimal support mode can be determined to be HBR3/2-lanes or HBR2/4-lanes. The transmission bandwidth corresponding to HBR3/2-lanes is 1620 MB/s, which is greater than the total display bandwidth of 1599 MB/s, and the difference between the transmission bandwidth corresponding to HBR3/2-lanes and the total display bandwidth is less than 850 MB/s. The transmission bandwidth corresponding to HBR2/4-lanes is 2160 MB/s, which is also greater than the total display bandwidth of 1599 MB/s, and the difference between the transmission bandwidth corresponding to HBR2/4-lanes and the total display bandwidth is also less than 850 MB/s.

In other words, the media docking device 100 obtains the device data from the media player devices 310, 320, and 330, and calculates and sums the display bandwidths required for the media player devices 310, 320, and 330 to display image. In this way, the media docking device 100 can adjust the optimal support mode for connecting the video interface unit 111 of the input interface controller 110 to the media source device 200, such that the transmission bandwidth corresponding to the optimal support mode is in a range of a sufficient transmission bandwidth rather than a highest transmission bandwidth. In other words, the media docking device 100 provided in the present disclosure can properly adjust the transmission bandwidth to achieve effect of power saving.

In detail, the present disclosure only needs the bandwidth corresponding to the optimal support mode to be greater than the total display bandwidth (so that the image quality that the media docking device 100 outputs to the media player devices 310, 320, and 330 can be maintained without compromising). Therefore, there is more than one support mode that meets the requirements (for example, in the aforementioned example, HBR3/2-lanes and HBR2/4-lanes both meet the requirements). However, in practice, a support mode that has a transmission bandwidth as close to the total display bandwidth as possible is selected to reduce the waste of transmission bandwidth and achieve effect of reducing power consumption and better power saving. Therefore, the present disclosure sets a first threshold to achieve the aforementioned requirements.

According to the aforementioned description, in a preferred embodiment of the present disclosure, a support mode that has a transmission bandwidth closest to the total display bandwidth is selected as the optimal support mode (for example, in the aforementioned example, HBR3/2-lanes will be selected as the optimal support mode of the preferred embodiment), thereby optimally reducing the waste of transmission bandwidth and achieving effect of best power consumption reduction and best power saving.

Finally, after the processor 120 has determined the aforementioned optimal support mode, the processor 120 will modify a first parameter of the input interface controller 110 for performing link training on the media source device 200 via the video interface unit 111 according to the optimal support mode, such that the media docking device 100 and the media source device 200 can perform audio and video transmission in this optimal support mode.

To further illustrate, if the video interface unit 111 of the media docking device 100 connected to the media source device 200 is a circuit that complies with specifications of DP, a circuit that complies with specifications of AUX channel will be used as the data transmission interface, and the transmission related to link training will use a value of address corresponding to Display Port Configuration Data (DPCD) to communicate. In other words, if the video interface unit 111 is a circuit that complies with specifications of DP, the first parameter is the value of address corresponding to DPCD. For example, the media source device 200 will use the circuit that complies with specifications of AUX channel to read the relevant capabilities (such as the maximum supported transmission bandwidth, the maximum supported lanes, and whether Display Stream Compression (DSC) is supported) of the circuit of the media docking device 100 that complies with specifications of DP. Therefore, the media docking device 100 can modify the corresponding value (e.g., 00100h and 00101h) of address corresponding to DPCD according to the determined optimal support mode, thereby allowing the media docking device 100 and the media source device 200 to perform audio and video transmission in the optimal support mode.

For example, the maximum supported transmission bandwidth supported by the video interface unit 111 of the input interface controller 110 of the media docking device 100 can correspond to the support mode of HBR3/4-lanes, but the media player device connected to the output interface controller 130 is only one monitor with a resolution of 4K/60 Hz. After the aforementioned calculation by the processor 120, the optimal support mode can be determined to be HBR3/2-lanes or HBR2/4-lanes, such that the media docking device 100 and the media source device 200 can use HBR3/2-lanes or HBR2/4-lanes to perform audio and video transmission, thereby achieving effect of reducing power consumption.

For another example, the maximum supported transmission bandwidth supported by the video interface unit 111 of the input interface controller 110 of the media docking device 100 can correspond to the support mode of HBR3/4-lanes, but the media player devices connected to the output interface controller 130 are three monitors with the resolution of FHD/60 Hz. After the aforementioned calculation by the processor 120, the optimal support mode can be determined to be HBR3/2-lanes or HBR2/4-lanes, such that the media docking device 100 and the media source device 200 can use HBR3/2-lanes or HBR2/4-lanes to perform audio and video transmission, thereby achieving effect of reducing power consumption.

On the other hand, if the video interface unit 111 of the media docking device 100 connected to the media source device 200 is a circuit that complies with specifications of HDMI, a circuit that complies with specifications of DDC will be used as the data transmission interface, and the transmission related to link training will use the value of address corresponding to Status and Control Data Channel (SCDC) to communicate. The media source device 200 will use the content of EDID (such as the parameter of “Max FRL rate” contained in the field of “HF Vendor Specific Data Block” in EDID) to read the relevant capabilities of the circuit of the media docking device 100 that complies with specifications of HDMI. In other words, if the video interface unit 111 is a circuit that complies with specifications of HDMI, the first parameter is one of fields of EDID. Therefore, the processor 120 of the media docking device 100 can modify the aforementioned parameter of the aforementioned field of EDID according to the determined optimal support mode, thereby allowing the media docking device 100 and the media source device 200 to perform audio and video transmission in the optimal support mode.

In addition, when the video interface unit 111 of the media docking device 100 connected to the media source device 200 adopts a manner of DSC for transmission, the media docking device 100 will also consume a lot of power due to processing the DSC signal. Therefore, in some embodiments of the present disclosure, the processor 120 can determine whether to transmit without adopting the manner of DSC. According to the determination result, the relevant parameters can be modified accordingly so that video interface unit 111 of the media docking device 100 connected to the media source device 200 does not adopt the manner of DSC for transmission, thereby significantly reducing the power consumption of the media docking device 100.

The input interface controller 110 of the media docking device 100 receives media data from the media source device 200. The media data may be, for example, a video or an image, or other types of data including audio. Next, the processor 120 calculates a stream bandwidth required for the media data based on the media data. Then, the processor 120 determines whether the stream bandwidth is greater than the total display bandwidth of the media player devices 310, 320, and 330. If the stream bandwidth is greater than the total display bandwidth, the processor 120 modifies a second parameter of the input interface controller 110 for performing link training on the media source device 200 via the video interface unit 111, thereby declaring that the video interface unit 111 does not support DSC. Thus, the media source device 200 considers that the video interface unit 111 does not support DSC, so that the video interface unit 111 does not adopt the manner of DSC to transmit, thereby achieving effect of reducing the power consumption of the media docking device 100.

To further illustrate, if the video interface unit 111 of the media docking device 100 connected to the media source device 200 is a circuit that complies with specifications of DP, the processor 120 can modify a value (for example, 00060h) of address corresponding to DPCD, so that the video interface unit 111 does not adopt the manner of DSC for transmission. In other words, if the video interface unit 111 is a circuit that complies with specifications of DP, the second parameter is the value of address corresponding to DPCD.

On the other hand, if the video interface unit 111 of the media docking device 100 connected to the media source device 200 is a circuit that complies with specifications of HDMI, the processor 120 can modify the parameter related to DSC, and the aforementioned parameter contains in the field of “HF Vendor Specific Data Block” in EDID. The aforementioned parameter is, for example, “DSC_10bpc”, “DSC_12bpc”, “DSC_1p2” or “DSC_Max_FRL_Rate”. In other words, if the video interface unit 111 is a circuit that complies with specifications of HDMI, the second parameter is one or more of the fields of EDID.

The following further describes the process of the processor 120 determining the optimal support mode for connecting the video interface unit 111 to the media source device 200 based on the total display bandwidth.

For example, the aforementioned video interface unit 111 includes plural preset support modes: RBR/1-lane, HBR/1-lane, RBR/2-lanes, HBR/2-lanes, HBR2/1-lane, RBR/4-lanes, HBR3/1-lane, HBR/4-lanes, HBR2/2-lanes, HBR3/2-lanes, HBR2/4-lanes, HBR3/4-lanes, UHBR10/1-lane, UHBR10/2-lanes, UHBR10/4-lanes, UHBR13.5/1-lane, UHBR13.5/2-lanes, UHBR13.5/4-lanes, UHBR20/1-lane, UHBR20/2-lanes, UHBR20/4-lanes.

Next, the processor 120 calculates the transmission bandwidths respectively corresponding to the aforementioned preset support modes. The transmission bandwidth corresponding to RBR/1-lane is 1.62 (Gbps)*1 (lane)*1000 (Mbps/Gbps)*⅛ (Byte/bits)* 8/10 (8b/10b encoding)=162 MB/s. The transmission bandwidth corresponding to HBR/1-lane is 2.7 (Gbps)*1 (lane)*1000 (Mbps/Gbps)*⅛ (Byte/bits)* 8/10 (8b/10b encoding)=270 MB/s. The transmission bandwidth corresponding to RBR/2-lanes is 1.62 (Gbps)*2 (lanes)*1000 (Mbps/Gbps)*⅛ (Byte/bits)* 8/10 (8b/10b encoding)=324 MB/s. The transmission bandwidth corresponding to HBR/2-lanes is 2.7 (Gbps)*2 (lanes)*1000 (Mbps/Gbps)*⅛ (Byte/bits)* 8/10 (8b/10b encoding)=540 MB/s. The transmission bandwidth corresponding to HBR2/1-lane is 5.4 (Gbps)*1 (lane)*1000 (Mbps/Gbps)*⅛ (Byte/bits)* 8/10 (8b/10b encoding)=540 MB/s. The transmission bandwidth corresponding to RBR/4-lanes is 1.62 (Gbps)*4 (lanes)*1000 (Mbps/Gbps)*⅛ (Byte/bits)* 8/10 (8b/10b encoding)=648 MB/s. The transmission bandwidth corresponding to HBR3/1-lane is 8.1 (Gbps)*1 (lane)*1000 (Mbps/Gbps)*⅛ (Byte/bits)* 8/10 (8b/10b encoding)=810 MB/s. The transmission bandwidth corresponding to HBR/4-lanes is 2.7 (Gbps)*4 (lanes)*1000 (Mbps/Gbps)*⅛ (Byte/bits)* 8/10 (8b/10b encoding)=1080 MB/s. The transmission bandwidth corresponding to HBR2/2-lanes is 5.4 (Gbps)*2 (lanes)*1000 (Mbps/Gbps)*⅛ (Byte/bits)* 8/10 (8b/10b encoding)=1080 MB/s. The transmission bandwidth corresponding to HBR3/2-lanes is 1620 MB/s. The transmission bandwidth corresponding to HBR2/4-lanes is 2160 MB/s. The transmission bandwidth corresponding to HBR3/4-lanes is 8.1 (Gbps)*4 (lanes)*1000 (Mbps/Gbps)*⅛ (Byte/bits)* 8/10 (8b/10b encoding)=3240 MB/s. The above calculation is merely an example, and the actual transmission bandwidth can be calculated according to the specification definition of the DisplayPort published by Video Electronics Standards Association (VESA).

Then, since the transmission bandwidth corresponding to the optimal support mode is greater than the total display bandwidth, and the difference between the transmission bandwidth corresponding to the optimal support mode and the total display bandwidth is less than the first threshold, the processor 120 compares the transmission bandwidths corresponding to the aforementioned preset support modes with the total display bandwidth, and selects at least one preset support mode whose transmission bandwidth is greater than the total display bandwidth and whose difference between the transmission bandwidth and the total display bandwidth is less than the first threshold as the optimal support mode.

On the other hand, in a preferred embodiment of the present disclosure, since the transmission bandwidth corresponding to the optimal support mode is greater than the total display bandwidth, and the transmission bandwidth corresponding to the optimal support mode is closest to the total display bandwidth, the processor 120 compares the transmission bandwidths, in small-to-large order, corresponding to the aforementioned preset support modes with the total display bandwidth sequentially. As long as the transmission bandwidth corresponding to one of the preset support modes is greater than or equal to the total display bandwidth, the one of the preset support modes is set as the optimal support mode in the preferred embodiment of the present disclosure. In other words, in the preferred embodiment of the present disclosure, the one of the preset support modes is set as the optimal support mode, in response to a comparison result that the transmission bandwidth corresponding to the one of the preset support modes is already greater than or equal to the total display bandwidth.

For example, when the total display bandwidth is 1336.5 MB/s, the processor 120 starts the aforementioned comparison from the preset supported mode (i.e., RBR/1-lane (the corresponding transmission bandwidth is 162 MB/s)) with the smallest transmission bandwidth. Next, the processor 120 continues the aforementioned comparison with, in order, HBR/1-lane (the corresponding transmission bandwidth is 270 MB/s), RBR/2-lanes (the corresponding transmission bandwidth is 324 MB/s), HBR/2-lanes and HBR2/1-lane (the corresponding transmission bandwidths are both 540 MB/s), RBR/4-lanes (the corresponding transmission bandwidth is 648 MB/s), HBR3/1-lane (the corresponding transmission bandwidth is 810 MB/s), HBR/4-lanes and HBR2/2-lanes (the corresponding transmission bandwidth are both 1080 MB/s), and HBR3/2-lanes (the corresponding transmission bandwidth is 1620 MB/s). Since the transmission bandwidth of 1620 MB/s corresponding to HBR3/2-lanes 2 is greater than or equal to the total display bandwidth of 1336.5 MB/s, the preset supported mode with HBR3/2-lanes is selected as the optimal support mode in the preferred embodiment of the present disclosure.

Alternatively, the processor 120 compares the transmission bandwidths, in large-to-small order, corresponding to the aforementioned preset support modes with the total display bandwidth sequentially. As long as the transmission bandwidth corresponding to one of the preset support modes is less than the total display bandwidth, a former one of the preset support modes is set as the optimal support mode in the preferred embodiment of the present disclosure. The former one of the preset support modes precedes the one of the preset support modes with respect to the transmission bandwidths, in large-to-small order, corresponding to the preset support modes sequentially. In other words, in the preferred embodiment of the present disclosure, the former one of the preset support modes is set as the optimal support mode, in response to a comparison result that the transmission bandwidth corresponding to the one of the preset support modes is already less than to the total display bandwidth.

For example, when the total display bandwidth is 1336.5 MB/s, the processor 120 starts the aforementioned comparison from the preset supported mode (i.e., HBR3/4-lanes (the corresponding transmission bandwidth is 3240 MB/s)) with the largest transmission bandwidth. Next, the processor 120 continues the aforementioned comparison with, in order, HBR2/4-lanes (the corresponding transmission bandwidth is 2160 MB/s), HBR3/2-lanes (the corresponding transmission bandwidth is 1620 MB/s), HBR/4-lanes and HBR2/2-lanes (the corresponding transmission bandwidths are both 1080 MB/s). Since the transmission bandwidth of 1080 MB/s corresponding to HBR/4-lanes or HBR2/2-lanes is less than the total display bandwidth of 1336.5 MB/s, the former one (i.e., HBR3/2-lanes) of the preset supported mode preceding HBR/4-lanes or HBR2/2-lanes is selected as the optimal support mode in the preferred embodiment of the present disclosure.

In some embodiments, the basis for the processor 120 to determine the optimal support mode may also vary depending on the power supply method of the media docking device 100. When the media docking device 100 is powered by an external power adapter, there is no need to consider the issue of power saving and low power consumption, and thus some margin can be reserved for adjusting the transmission bandwidth, thereby providing better user experience. For example, when there is only one media player device connected to the media docking device, the requirement of transmission bandwidth is relatively low, and the support mode with a lower transmission bandwidth can be selected. However, when there is another media player device subsequently connected to the media docking device, if the transmission bandwidth of the current support mode is insufficient, the media docking device 100 needs to re-perform link training with the media source device 200, which will lead to a poor user experience. When the processor 120 knows that the media docking device 100 is currently powered by the external power adapter, some margin can be reserved for adjusting the transmission bandwidth, that is, the support mode with a higher transmission bandwidth is selected. Thus, when another media player device is subsequently connected to the media docking device, the media docking device 100 does not need to re-perform link training with the media source device 200, thereby providing a better user experience.

On the other hand, when the media docking device 100 is powered by the media source device 200, the issue of power saving and low power consumption needs to be considered to prevent the excessive power consumption of the media docking device 100 from causing a significantly decrease in life of the battery of the media source device 200 (e.g., the laptop). Specifically, the processor 120 determines whether the media docking device 100 is powered by the media source device 200. If the media docking device 100 is powered by the media source device 200, the processor 120 compares the transmission bandwidths, in small-to-large order, corresponding to the preset support modes included in the video interface unit 111 with the total display bandwidth sequentially. As long as the transmission bandwidth corresponding to one of the preset support modes is greater than or equal to the total display bandwidth, the one of the preset support modes is set as the optimal support mode. That is, the preset support mode that has the transmission bandwidth closest to the total display bandwidth is selected as the optimal support mode, thereby optimally reducing the waste of transmission bandwidth and achieving effect of best power consumption reduction and best power saving. Alternatively, the processor 120 determines whether the media docking device 100 is powered by the media source device 200. If the media docking device 100 is powered by the media source device 200, the processor 120 compares the transmission bandwidths, in large-to-small order, corresponding to the preset support modes included in the video interface unit 111 with the total display bandwidth sequentially. As long as the transmission bandwidth corresponding to one of the preset support modes is less than the total display bandwidth, a former one of the preset support modes is set as the optimal support mode. The former one of the preset support modes precedes the one of the preset support modes with respect to the transmission bandwidths, in large-to-small order, corresponding to the preset support modes sequentially. That is, the preset support mode that has the transmission bandwidth closest to the total display bandwidth is selected as the optimal support mode, thereby optimally reducing the waste of transmission bandwidth and achieving effect of best power consumption reduction and best power saving.

In addition, the support mode of the video interface unit 131 of the output interface controller 130 for connecting to the media player device can also be selected in a similar manner. The processor 120 calculates the display bandwidth required for each media player device to display image based on the device data obtained from the media player device. Then, the processor 120 determines the output support mode for connecting the video interface unit 131 of the output interface controller 130 to each media player device based on the display bandwidth of each media player device. The transmission bandwidth corresponding to the output support mode of each media player device is greater than the display bandwidth of each media player device. Furthermore, in a preferred embodiment of the present disclosure, the support mode with the transmission bandwidth closest to the display bandwidth is selected, thereby optimally reducing the waste of transmission bandwidth and achieving effect of best power consumption reduction and best power saving.

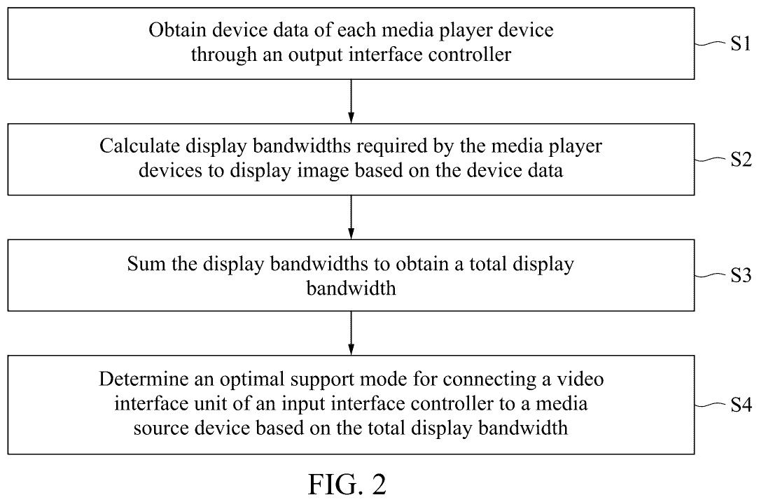

FIG. 2 is a flowchart of a media docking method according to some embodiments of the present disclosure. The media docking method is executed by the media docking device 100 and includes Steps S1 to S4. In Step S1, device data of each media player device (e.g., the media player devices 310, 320, and 330) is obtained through the output interface controller 130 of the media docking device 100. In Step S2, the processor 120 of the media docking device 100 calculates the display bandwidths required by the media player devices to display image based on the device data. In Step S3, the processor 120 sums the display bandwidths of the media player devices to obtain the total display bandwidth. In Step S4, the processor 120 determines the optimal support mode for connecting the video interface unit 111 of the input interface controller 110 of the media docking device 100 to the media source device 200 based on the total display bandwidth. The transmission bandwidth corresponding to the optimal support mode is greater than the total display bandwidth, and the difference between the transmission bandwidth corresponding to the optimal support mode and the total display bandwidth is less than a first threshold. The steps in FIG. 2 have been described in detail above and will not be repeated here. It should be noted that each step in FIG. 2 can be implemented as plural program codes or circuits, and the present disclosure is not limited thereto. In addition, the media docking method of FIG. 2 can be used in conjunction with the aforementioned embodiments or can be used alone. In other words, another step can be added between the steps of FIG. 2.

The aforementioned description is to determine the optimal support mode for connecting the video interface unit 111 of the input interface controller 110 of the media docking device 100 to the media source device 200 according to the total transmission bandwidth of the media player devices connected to the output interface controller 130 of the media docking device 100. On the other hand, the optimal output support mode for connecting the video interface unit 131 of the output interface controller 130 of the media docking device 100 to the media player devices may be determined according to the stream bandwidth of the media source device 200 connected to the input interface controller 110 of the media docking device 100.

The input interface controller 110 of the media docking device 100 receives media data from the media source device 200. Next, the processor 120 calculates the stream bandwidth required for the media data based on the media data. Then, the processor 120 determines the optimal output support mode for connecting the video interface unit 131 of the output interface controller 130 to each of the media player devices 310, 320, and 330 based on the stream bandwidth. The sum of the transmission bandwidths corresponding to the optimal output support mode of the media player devices is less than the stream bandwidth, and the difference between the sum of the transmission bandwidths corresponding to the optimal output support mode of each media player devices and the stream bandwidth is less than a second threshold. The second threshold can be set according to actual needs, but the present disclosure does not limit thereto. The optimal output support mode includes a bit rate configuration via N lanes. The bit rate configuration is RBR, HBR, HBR2, HBR3, UHBR10, UHBR13.5 or UHBR20, and N is 1, 2 or 4.

In other words, the media docking device 100 obtains the media data from the media source device 200 and accordingly calculates the stream bandwidth required by the media source device 200. In this way, the media docking device 100 can adjust the output support mode (also called the optimal output support mode) for connecting the video interface unit 131 of the output interface controller 130 to the media player device, such that the transmission bandwidth corresponding to the optimal output support mode is in a range of a sufficient transmission bandwidth rather than a highest transmission bandwidth, thereby achieving effect of power saving.

The advantage of the aforementioned optimal output support mode is that if the media player device is a 4K monitor, but the media source device 200 only wants to display at a FHD resolution, the optimal output support mode can be used to achieve effect of power saving.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A media docking device, comprising:
an input interface controller connected to a media source device;
an output interface controller connected to at least one media player device and configured to obtain device data of each of the at least one media player device; and
a processor connected to the input interface controller and the output interface controller and configured to:
calculate display bandwidths required by the at least one media player device to display image based on the device data;
sum the display bandwidths to obtain a total display bandwidth; and
determine an optimal support mode for connecting a video interface unit of the input interface controller to the media source device based on the total display bandwidth;
wherein a transmission bandwidth corresponding to the optimal support mode is greater than the total display bandwidth, and a difference between the transmission bandwidth corresponding to the optimal support mode and the total display bandwidth is less than a first threshold.

2. The media docking device of claim 1, wherein the optimal support mode includes a bit rate configuration via N lanes, wherein the bit rate configuration is reduced bit rate (RBR), high bit rate (HBR), high bit rate 2 (HBR2), high bit rate 3 (HBR3), ultra-high bit rate 10 (UHBR10), ultra-high bit rate 13.5 (UHBR13.5), or ultra-high bit rate 20 (UHBR20), wherein N is 1, 2, or 4.

3. The media docking device of claim 1, wherein the processor is further configured to:
modify a first parameter of the input interface controller for performing link training on the media source device via the video interface unit according to the optimal support mode.

4. The media docking device of claim 3, wherein the first parameter is a value of address corresponding to DisplayPort Configuration Data (DPCD) if the video interface unit is DisplayPort (DP).

5. The media docking device of claim 3, wherein the first parameter is one of fields of Extended display identification data (EDID) if the video interface unit is High Definition Multimedia Interface (HDMI).

6. The media docking device of claim 1, wherein the device data is one of fields of EDID and the device data is configured to declare a pixel clock.

7. The media docking device of claim 1, wherein the input interface controller is configured to receive media data of the media source device, wherein the processor is further configured to:
calculate a stream bandwidth required for the media data based on the media data;
determine whether the stream bandwidth is greater than the total display bandwidth; and
modify a second parameter of the input interface controller for performing link training on the media source device via the video interface unit if the stream bandwidth is greater than the total display bandwidth, such that the video interface unit does not adopt Display Stream Compression (DSC) for transmission.

8. The media docking device of claim 1, wherein the video interface unit includes plural preset support modes, wherein the processor is further configured to:
determine whether the media docking device is powered by the media source device;
compare transmission bandwidths, in small-to-large order, corresponding to the preset support modes with the total display bandwidth sequentially; and
set one of the preset support modes as the optimal support mode, in response to a comparison result that a transmission bandwidth corresponding to the one of the preset support modes is already greater than or equal to the total display bandwidth.

9. The media docking device of claim 1, wherein the video interface unit includes plural preset support modes, wherein the processor is further configured to:
determine whether the media docking device is powered by the media source device;
compare transmission bandwidths, in large-to-small order, corresponding to the preset support modes with the total display bandwidth sequentially; and
set a former one of the preset support modes as the optimal support mode, in response to a comparison result that a transmission bandwidth corresponding to one of the preset support modes is already less than the total display bandwidth;
wherein the former one of the preset support modes precedes the one of the preset support modes with respect to the transmission bandwidths, in large-to-small order, corresponding to the preset support modes sequentially.

10. The media docking device of claim 1, wherein the input interface controller is configured to receive media data of the media source device, wherein the processor is further configured to:
calculate a stream bandwidth required for the media data based on the media data; and
determine an optimal output support mode for connecting a video interface unit of the output interface controller to each of the at least one media player device based on the stream bandwidth;
wherein a sum of transmission bandwidths corresponding to the optimal output support mode of the at least one media player device is less than the stream bandwidth, and a difference between the sum and the stream bandwidth is less than a second threshold.

11. A media docking method, comprising:
obtaining device data of each of at least one media player device through an output interface controller;
calculating display bandwidths required by the at least one media player device to display image based on the device data;
summing the display bandwidths to obtain a total display bandwidth; and
determining an optimal support mode for connecting a video interface unit of an input interface controller to a media source device based on the total display bandwidth;
wherein a transmission bandwidth corresponding to the optimal support mode is greater than the total display bandwidth, and a difference between the transmission bandwidth corresponding to the optimal support mode and the total display bandwidth is less than a first threshold.

12. The media docking method of claim 11, wherein the optimal support mode includes a bit rate configuration via N lanes, wherein the bit rate configuration is RBR, HBR, HBR2, HBR3, UHBR10, UHBR13.5, or UHBR20, wherein N is 1, 2, or 4.

13. The media docking method of claim 11, further comprising:
modifying a first parameter of the input interface controller for performing link training on the media source device via the video interface unit according to the optimal support mode.

14. The media docking method of claim 13, wherein the first parameter is a value of address corresponding to DPCD if the video interface unit is DP.

15. The media docking method of claim 13, wherein the first parameter is one of fields of EDID if the video interface unit is HDMI.

16. The media docking method of claim 11, wherein the device data is one of fields of EDID and the device data is configured to declare a pixel clock.

17. The media docking method of claim 11, further comprising:
receiving media data of the media source device through the input interface controller;
calculating a stream bandwidth required for the media data based on the media data;
determining whether the stream bandwidth is greater than the total display bandwidth; and
modifying a second parameter of the input interface controller for performing link training on the media source device via the video interface unit if the stream bandwidth is greater than the total display bandwidth, such that the video interface unit does not adopt Display Stream Compression (DSC) for transmission.

18. The media docking method of claim 11, wherein the video interface unit includes plural preset support modes, wherein the media docking method further comprises:
determining whether the media docking device is powered by the media source device;
comparing transmission bandwidths, in small-to-large order, corresponding to the preset support modes with the total display bandwidth sequentially; and
setting one of the preset support modes as the optimal support mode, in response to a comparison result that a transmission bandwidth corresponding to the one of the preset support modes is already greater than or equal to the total display bandwidth.

19. The media docking method of claim 11, wherein the video interface unit includes plural preset support modes, wherein the media docking method further comprises:
determining whether the media docking device is powered by the media source device;
comparing transmission bandwidths, in large-to-small order, corresponding to the preset support modes with the total display bandwidth sequentially; and
setting a former one of the preset support modes as the optimal support mode, in response to a comparison result that a transmission bandwidth corresponding to one of the preset support modes is already less than the total display bandwidth;
wherein the former one of the preset support modes precedes the one of the preset support modes with respect to the transmission bandwidths, in large-to-small order, corresponding to the preset support modes sequentially.

20. The media docking method of claim 11, further comprising:
receiving media data of the media source device through the input interface controller;
calculating a stream bandwidth required for the media data based on the media data; and
determining an optimal output support mode for connecting a video interface unit of the output interface controller to each of the at least one media player device based on the stream bandwidth;
wherein a sum of transmission bandwidths corresponding to the optimal output support mode of the at least one media player device is less than the stream bandwidth, and a difference between the sum and the stream bandwidth is less than a second threshold.
